(19) United States
(12) Patent Application Publication
(10) Pub. No.: US 2023/0036024 A1
(43) Pub. Date: Feb. 2, 2023

(54) CONTACT MODULE

(71) Applicant: Phoenix Contact Asia-Pacific (Nanjing) Co., Ltd., Nanjing (CN)

(72) Inventors: Jinxue Chen, Nanjing (CN); Jinge Liu, Nanjing (CN)

(21) Appl. No.: 17/788,714

(22) PCT Filed: Nov. 27, 2020
(86) PCT No.: PCT/CN2020/132175

§ 371 Date: Jun. 23, 2022

(30) Foreign Application Priority Data
Dec. 24, 2019 (CN) 201911343847.9

(51) Int. Cl. H01H 1/58; H01R 4/48

(52) U.S. Cl. CPC H01H 1/5844; H01R 4/4845; H01R 4/4827

(57) ABSTRACT

In some examples, a contact module comprising housing, middle pole, wiring unit body, wherein the middle pole and the wiring unit are disposed in the housing; the middle pole moves up and down in the housing to realize the connection or disconnection between the middle pole and the wiring unit; the wiring unit body is disposed inside the housing, and the wiring unit body is provided therein with electrically conductive part for realizing the connection between conductor wire and the wiring unit body, and a pressing part for realizing the withdrawal of the conductor wire from the electrically conductive part provided in the wiring unit body, and the conductor wire connected into the electrically conductive part can be quickly pulled out by operating the pressing part wherein the housing is provided with conductor insertion port for the conductor wire to be inserted into the electrically conductive part.

This application is a national stage application under 35 U.S.C. § 371 of International Application No. PCT/CN2020/132175, filed Nov. 27, 2020, which claims priority of Chinese Patent Application No. 201911343847.9, filed Dec. 24, 2019. The entire contents of each of Application Nos. PCT/CN2020/132175 and CN 201911343847.9 are incorporated herein by reference in their respective entireties.

### TECHNICAL FIELD

The present disclosure relates to the field of electrical connection, and belongs to a type of contact module.

### BACKGROUND

Switch wiring apparatus is a power switch assembly with a connecting circuit or connecting line, which is to be installed on the operation panel or distribution box of electronic and electrical device to have the electrical distribution circuits connected. The switch wiring apparatus, through the use of electrically conductive elements and screw to secure electrical distribution circuits or conductor wires of electronics or electromechanical device housed within an insulating housing (usually made of plastic material), and through coordination with the operation of switch buttons to control the conduction or de-conduction between electrically conductive elements and electrical distribution circuits or conductor wires, achieves a function of turning on or off power supply of circuits. This is a known technology. For example, the patent application 201310294137.8 entitled “Improved Structure of Switch” provides a typical embodiment.

A subject matter related to the operation, use and structural design of this type of switch wiring apparatus is that the insulating housing is provided with intercommunicating plug hole, and locking hole for operating screws so as to allow personnel to operate a tool to control the screw for locking of conductor wire entering from the plug holes. In practice, the screw must be in the released state first, so that the conductor wire can be inserted into the plug hole; when the screw is in the released state, the screw will be skewed, thus it often requires personnel to operate the screw to align with the operation of locking the conductor wire and electrical joint (or referred as electrical terminal), which is troublesome and difficult.

In order to improve the above-mentioned problems, the prior art also discloses a structure in which a guide groove, a guide bar and a spring are arranged on an insulating housing and an electrical joint. However, the structure is not only complicated, but also increases the manufacturing cost; and generally, the volume of the housing must be increased to avoid interference between the guiding structure and the electrically conductive elements. Furthermore, increasing the volume of the housing is also not favor to the evolution and design trend of miniaturization of the switch terminal apparatus.

In some application environments (for example, the operation of machinery and equipment will produce vibration), the long-term use process may easily loosen the screws, resulting in loose wires. In particular, the screw mechanism and the pivoting and connecting operations of the conductor or wire must use tools to achieve screwing and unscrewing operations, which is relatively troublesome; and this situation is not what we expect.

The prior art also discloses a structure designed to match the internal structure of the housing, using a metal elastic piece with a profile to press conductor or wire to replace the structure of screw mechanism for screwing the wire. However, as known by those familiar with the art, in addition to the work of bending the a-type metal elastic piece into a special shape, a opening must be formed on the metal elastic piece, so that the other end can pass through the opening to form a swingable structure in the opening to compress the wire. Therefore, the a-type metal elastic piece is relatively troublesome and complicated in structure manufacturing; and this situation is not what we expect.

Typically, these reference data show the technologies in the design of switch wiring apparatus and relevant combinations; if a redesign can be made by taking into account the structural combination of the insulating housing and electrically conductive elements, electrical joints and switches, to make its construction different from the conventional one, then it will be possible to change its form of application to be distinct from the old approach, and in essence, it's the scope of application will be increased. For example, under the prerequisite condition of not increasing the volume of switch wiring apparatus, their structures can be made to be favor to manufacture and operation, so as to improve the trouble and difficulty of the conventional operation of screw alignment of the locked conductor wire and the electrical joint, and the situation for the insulating housing to be combined with guide groove, guide bars and springs, and applying complex structures such as a-type metal elastic piece, etc.

Moreover, in the prior art, due to the limitation of product structure and use environment, it is an urgent problem to be solved to realize, on demand, quick connection and extraction of conductor wire without increasing the product volume while meeting product use requirements.

### SUMMARY

The purpose of the present disclosure is to provide a contact module that can realize rapid insertion and extraction of conductor wire, improve the wiring speed, and has higher safety, while not increasing the volume of the product.

In order to achieve the above purpose, the technical solution adopted in the present disclosure is: a contact module comprising housing, middle pole, wiring unit body, wherein the middle pole and the wiring unit are disposed in the housing; the middle pole moves up and down in the housing to realize the connection or disconnection between the middle pole and the wiring unit; the wiring unit body is disposed inside the housing, and the wiring unit body is provided therein with electrically conductive part for realizing the connection between conductor wire and the wiring unit body, and a pressing part for realizing the withdrawal of the conductor wire from the electrically conductive part provided in the wiring unit body, and the conductor wire connected into the electrically conductive part can be quickly pulled out by operating the pressing part; wherein the housing is provided with wire insertion port for the wire to be inserted into the electrically conductive part, wherein the housing is provided with pressing hole for accommodating the pressing part, the pressing part being capable of moving up and down along the central axis of the pressing hole.

It can be seen from the above technical contents that the beneficial effects of the present disclosure include that: the wiring unit body is provided therein with electrically conductive part for realizing the connection between the conductor wire and the wiring unit body, and a pressing part is for realizing the withdrawal of the conductor wire from the electrically conductive part provided in the wiring unit body, and the wire connected into the electrically conductive part can be quickly pulled out by operating the pressing part; this structure can make the pressing part move along the path set on the unit housing through the operation of the operating portion, so that the lower part of the pressing part is in contact with second elastic contact pin of the spring, and the pressing part is moved continuously to cause a gap between the second contact pin of the spring and the wire, so that the wire can be pulled out from the contact module. Meanwhile, this design is also convenient for subsequent testing and wire replacement.

The wiring unit body includes a unit housing, spring, and contact current bar. During the installation process, the spring and the contact current bar are separately fixed by the unit housing made of plastic and then installed in the housing, which makes the assembly more convenient. And the spring is surrounded by the contact current bars. Since the hardness of the contact current bar is higher than the hardness of the plastic in the prior art, the deformation of the unit housing made of plastic material is avoided when the use temperature is high. Meanwhile, as the contact current bar is metal, thus it has good electrical conductivity, has a better function of realizing power transmission, and is easy for personnel to operate. It also overcomes the problems caused by the approach in the prior art, including a bare metal end of the conductor wire damaging the housing or causing deflection of the metal elastic piece, scratching the housing, unstable clamping, etc.

Compared with the prior art, situations in the prior art are significantly improved, the situations improved comprising: where the disassembly and assembly of the electrical distribution circuit or the conductor wire through troublesome operation of screw locking and loosening is necessary, the screw may be skewed when the screw is in the loosened state, causing trouble and difficulty for personnel to operate the screw to align with the operation of locking the conductor wire and the electrical connector; or, the application of a-type metal elastic piece, providing matching structure on the insulating housing and the electrical joint for mating with guiding grooves, guiding bars and spring, would make the structure more complicated, increase the manufacturing cost and the volume of the casing; or, loosening of the screws and conductor wire rod caused by the vibration of the machine and equipment, etc.

Compared with the prior art where the insertion port for the conductor wire is designed at the lower end of the product, in the present disclosure the extension line of the insertion port for the conductor wire intersects with the extension line of the movement direction of the middle pole, and the side of the housing is provided with a conductor wire insertion port for the conductor wire to be inserted into the electrically conductive part. This wiring method enables multiple contact modules to be superimposed when multiple contact modules need to be connected, which improves the application scenario of the product.

It is to be understood that all combinations of the foregoing concepts, as well as additional concepts described in greater detail below, are considered to be part of the inventive subject matter of the present disclosure to the extent that such concepts are not contradictory. Additionally, all combinations of the claimed subject matter are considered to be part of the inventive subject matter of this disclosure.

The foregoing and other aspects, examples and features of the present teachings can be more fully understood from the following description when taken in conjunction with the accompanying drawings. Other additional aspects of the disclosure, such as features and/or benefits of the exemplary examples, will be apparent from the description below, or learned by practice of specific examples in accordance with the teachings of the present disclosure.

### BRIEF DESCRIPTION OF DRAWINGS

The drawings are not intended to be drawn to scale. In the drawings, each identical or nearly identical component illustrated in various figures may be represented by the same reference numeral. For clarity, not every component is labeled in every figure. Examples of various aspects of the present disclosure will now be described by way of example and with reference to the accompanying drawings, wherein:

FIG. 1 is an exploded view of the contact module of the present disclosure.

FIG. 2 is a schematic diagram of the entirety of the contact module of the present disclosure.

FIG. 3 is a schematic structural diagram of a contact current bar.

FIG. 4 is a schematic diagram of structure of a spring.

FIG. 5 is a schematic structural diagram of a wiring unit body.

FIG. 6 is a schematic structural diagram of the contact module being a normally closed contact module.

FIG. 7 is a schematic structural diagram of the contact module being a normally open contact module.

FIG. 8 is a schematic structural diagram when two contact modules are superimposed.

FIG. 9 is a schematic structural diagram of the spring when one spring has two legs.

In the figure, the names of the reference numerals are as follows: 1. first shell, 2. middle pole main body, 3. pressing part, 4. spring, 5. unit housing, 6. contact current bar, 7. first contact spring, 8. contact slider, 9. second contact spring, 10. second shell, 11. mounting groove, 12. mounting leg, 13. conductor wire insertion port, 14. pressing groove, 15. second mounting side, 16. first mounting side, 17. connecting side, 18. first elastic contact pin, 19. fixing end, 20. second elastic contact pin, 21. fixing part, 22. first arm, 23. second arm, 24. middle separation cavity, 25. conductor wire, 26. first segment, 27. first leg, 28. second leg, 29. curved section, 30. test piece.

### DETAILED DESCRIPTION

In order to better understand the technical content of the present disclosure, specific examples are provided and described below in conjunction with the accompanying drawings.

Aspects of the disclosure are described in the present disclosure with reference to the accompanying drawings, in which a number of illustrative examples are shown. Examples of the present disclosure are not necessarily intended to include all aspects of the disclosure. It should be understood that the various concepts and examples described above, as well as those described in greater detail below, can be implemented in any of a variety of ways, as the concepts and examples disclosed herein are not limited to any implementation. Additionally, some aspects of the present disclosure may be used alone or in any suitable combination with other aspects of the present disclosure.

One skilled in the art will recognize that the various examples may be practiced without one or more of the specific details or with other alternative and/or additional methods, materials or components. In other instances, well-known structures, materials, or operations are not shown or described in detail so as not to obscure aspects of the various examples of the disclosure. Similarly, for purposes of explanation, specific quantities, materials and configurations are set forth in order to provide a thorough understanding of the examples of the disclosure. However, the present disclosure may be practiced without the specific details. Furthermore, it is to be understood that the various examples shown in the drawings are illustrative representations and are not necessarily drawn to scale.

Contact module is mainly used in the electrical connection parts in the button, and is used to realize the connection and disconnection of the connections with the related circuit at the bottom of the button through the movement of the button.

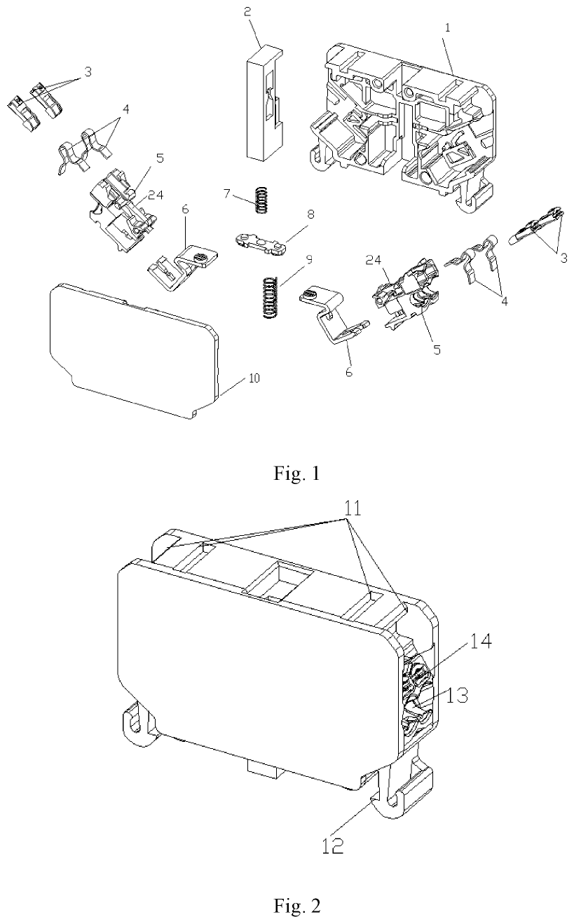

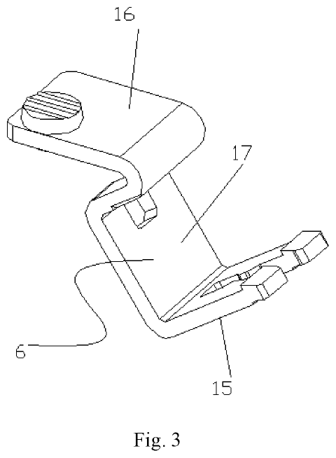

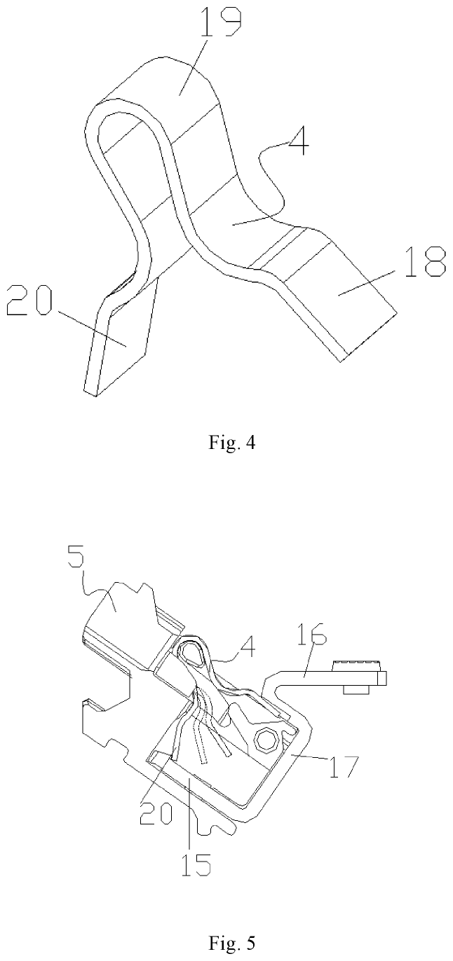

As shown in FIGS. 1-9, a contact module includes housing, middle pole, and wiring unit body, wherein the middle pole and the wiring unit are disposed in the housing.

The housing is separated into two parts, namely a first shell 1 and a second shell 10. The first shell 1 and the second shell 10 are closed to form a space for accommodating the middle pole and the wiring unit body.

The middle pole moves up and down in the housing to realize the connection or disconnection between the middle pole and the wiring unit.

The wiring unit body is disposed inside the housing. The wiring unit body is provided therein with an electrically conductive part for realizing the connection between the conductor wire 25 and the wiring unit body, and a pressing part 3 for realizing the withdrawal of the conductor wire 25 from the electrically conductive part provided in the wiring unit body. By operating the pressing part 3, the conductor wire 25 connected into the electrically conductive part can be quickly pulled out; wherein the housing is provided with a conductor wire insertion port 13 for the conductor wire 25 to be inserted into the electrically conductive part, wherein the housing is provided with pressing hole for accommodating the pressing part 3, and the pressing part 3 is capable of moving up and down along the central axis of the pressing hole.

The extension line of the insertion port 13 for the conductor wire 25 intersects the extension line of the movement direction of the middle pole. In the present disclosure, the insertion direction of the conductor wire 25 intersects with the movement direction of the middle pole, wherein the intersection angle between the extension line of insertion port 13 for the conductor wire 25 and the extension line of the movement direction of the middle pole can be a right angle or an acute angle. That is to say, it can be known that the insertion ports 13 for the conductor wires 25 are arranged on both sides of the housing, and in the design process, in order to realize the purpose of connecting and disconnecting the conductor wires 25, at least two insertion ports 13 for the conductor wires 25 are necessarily to be provided. And the distribution of insertion ports 13 for the conductor wires 25 can be in the form of linear distribution or symmetrical distribution. In the present disclosure, introduction is made mainly for the case where the insertion ports 13 for the conductor wires 25 are symmetrically distributed on both sides of the housing.

The wiring unit body includes unit housing 5, spring 4, and contact current bar 6, wherein: the contact current bar 6 is disposed in the unit housing 5, and one end of the contact current bar 6 is arranged to be in contact with or separated from the middle pole, and the other end of the contact current bar 6 is provided with spring installation cavity, wherein the spring(s) 4 is arranged in the spring installation cavity, and a middle part of the spring(s) 4 is sleeved on a fixing part 21 provided on the unit housing 5.

The middle pole of the housing is arranged in the middle of the housing, and wiring unit bodies are respectively provided on both sides of the middle pole. The middle pole includes middle pole main body 2, contact slider 8, first contact spring 7 and second contact spring 9, wherein: an installation cavity is provided in the middle pole main body 2, a first installation cavity and a second installation cavity are provided in the installation cavity, and the first contact spring 7 and the second contact spring 9 are respectively arranged in the first installation cavity and the second installation cavity; the contact slider 8 is disposed between the first contact spring 7 and the second contact spring 9; the contact slider 8 is provided with a first arm 22 and a second arm 23, and the first arm 22 and the second arm 23 are used to be in contact with or separated from the wiring unit bodies arranged on both sides of the middle pole.

The contact current bar 6 is arranged in the unit housing 5, and one end of the contact current bar 6 is arranged to be in contact with or separated from the middle pole, and the other end of the contact current bar 6 is provided with spring installation cavity, wherein the spring(s) 4 is arranged in the spring installation cavity, and the middle part of the spring(s) 4 is sleeved on the fixing part 21 provided on the unit housing 5.

The first arm 22 and the second arm 23 of the contact slider 8 have welding spots that are to be in contact with the contact current bars 6. The welding spots are silver welding spots, which are respectively used to be in contact with contacts on the contact current bar 6.

Contact point is provided on one end of the contact current bar 6 which is to be in contact with or separated from the middle pole, and the contact point is usually welding silver spot.

The wiring unit body includes unit housing 5, spring 4, and contact current bar 6, wherein: the contact current bar 6 is disposed in the unit housing 5, and one end of the contact current bar 6 is arranged to be in contact with or separated from the middle pole, and the other end of the contact current bar 6 is provided with spring installation cavity, wherein the spring(s) 4 is arranged in the spring installation cavity, and the middle part of the spring(s) 4 is sleeved on the fixing part 21 provided on the unit housing 5.

As shown in FIG. 5, in another example, the wiring unit body includes a unit housing 5, two springs 4, and a contact current bar 6, wherein: the contact current bar 6 is disposed in the unit housing 5, the unit housing 5 is provided therein with a middle separation cavity, and one spring 4 is disposed on each of both sides of the middle separation cavity respectively, and one end of the contact current bar 6 is arranged in contact with or separated from the middle bar. The other end of the contact current bar 6 is provided with a first pin and a second pin, wherein the first pin, the second pin and the contact current bar 6 form two spring installation cavities, wherein the two springs 4 are respectively arranged in the spring installation cavities, and a middle part of the spring 4 is sleeved on the fixing part 21 provided on the unit housing 5. The spring installation cavities have a first mounting side 16, a second mounting side 15, and a connecting side 17 connecting the first mounting side 16 and the second mounting side 15.

As shown in FIG. 5, the spring 4 has a fixing end 19, a first elastic contact pin 18 and a second elastic contact pin 20, wherein: the first elastic contact pin 18 is in contact with the first mounting side 16; the second elastic contact pin 20 is in contact with or separated from the second mounting side 15. When the conductor wire 25 enters the wiring unit, the conductor wire 25 is located between the second elastic contact pin 20 and the second mounting side 15. At this moment, the second elastic contact pin 20 is in a separated state from the second mounting side 15; when the conductor wire 25 exits the wiring unit, the second elastic contact pin 20 is in a contact state with the second mounting side 15. The dotted line in FIG. 5 shows the movement track of the spring 4 when the conductor wire 25 is inserted into the wiring unit. When the conductor wire 25 enters the wiring unit, the second elastic contact pin 20 swings around the fixing part 21 under the press from the conductor wire 25, and when the conductor wire 25 enters to reach a predetermined position, the second elastic contact pin 20 stops swinging, and is in close contact with the conductor wire 25 to prevent the conductor wire 25 from detaching from the wiring unit.

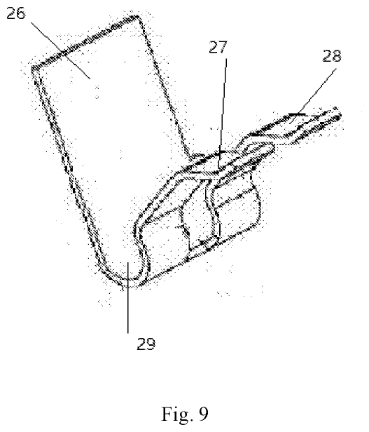

As shown in FIG. 9, in the implementation process, if two conductor wire insertion ports 13 are required to be provided in one wiring unit, a single spring 4 can be used. In this case, the spring 4 can be of V shape with an opening. It has a first section 26, a second section, and a curved section 29 connecting the first and second sections, wherein the first section 26 is in contact with the first mounting side 16 of the spring installation cavity, the second section is a bifurcated structure so as to have a first leg 27 and a second leg 28, wherein the first leg 27 and the second leg 28 are located on both sides of the middle separation cavity 24, respectively. The first leg 27 and the second leg 28 are respectively in contact with or separated from the second mounting side 15. When the conductor wires 25 are inserted into the wiring unit from the two conductor wire insertion ports 13, the conductor wires 25 are located between the first leg 27 and the second mounting side 15 and between the second leg 28 and the second mounting side 15, respectively, and at this moment, the first leg 27 and the second leg 28 are both in a separated state from the second mounting side 15; when the conductor wires 25 are extracted from the wiring unit body, the first leg 27 and the second leg 28 are automatically brought into contact with the second mounting side 15 under the force applied by the spring 4.

The spring installation cavity has a first mounting side 16, a second mounting side 15, and a connecting side 17 connecting the first mounting side 16 and the second mounting side 15.

The unit housing 5 cooperates with the housing to form a space for accommodating the spring 4 and the contact current bar 6.

The pressing part 3 includes a pressing main body, wherein a pressing groove 14 is provided on an upper end surface of the pressing main body. The pressing groove 14 is used for accommodating operating mechanism, so as to facilitate the operation of the pressing part 3 to move along the wiring unit body.

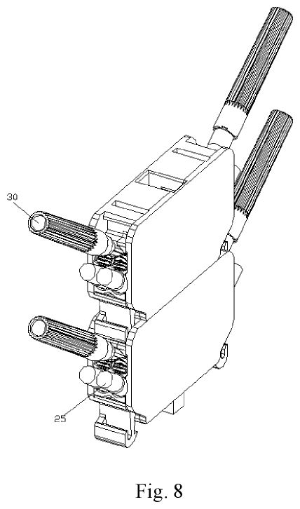

As shown in FIG. 8, the bottom of the housing is provided with mounting legs 12, and an upper part of the housing is provided with mounting grooves 11, wherein the mounting legs 12 can be matched with the mounting grooves 11, and the cooperation of the mounting legs 12 and the mounting grooves 11 is used to realize the superposition of multiple contact modules.

As shown in FIG. 8, a test hole is provided on the upper part of the pressing part 3. The extension line of the central axis of the test hole intersects with the middle pole body 2, wherein the intersection angle between the extension line of the central axis of the test hole and the middle pole body can be a right angle or an acute angle. When the intersection angle of the extension line of the wire insertion port 13 intersecting with the extension line of the movement direction of the middle pole is a right angle, then the intersection angle between the extension line of the central axis of the test hole and the middle pole body can be a right angle or an acute angle; and, when the intersection angle of the extension line of the conductor wire insertion port 13 intersecting with the extension line of the movement direction of the middle pole is an acute angle, then the intersection angle between the extension line of the central axis of the test hole and the middle pole body can be a right angle or an acute angle. In order to save the volume of the product, the central axis of the test hole is parallel to the extension line of the conductor wire insertion port 13 during the implementation process.

A test piece 30 is arranged in the test hole, and the test piece 30 is used to test each wiring unit body, so as to facilitate detection and maintenance for faults during connection process.

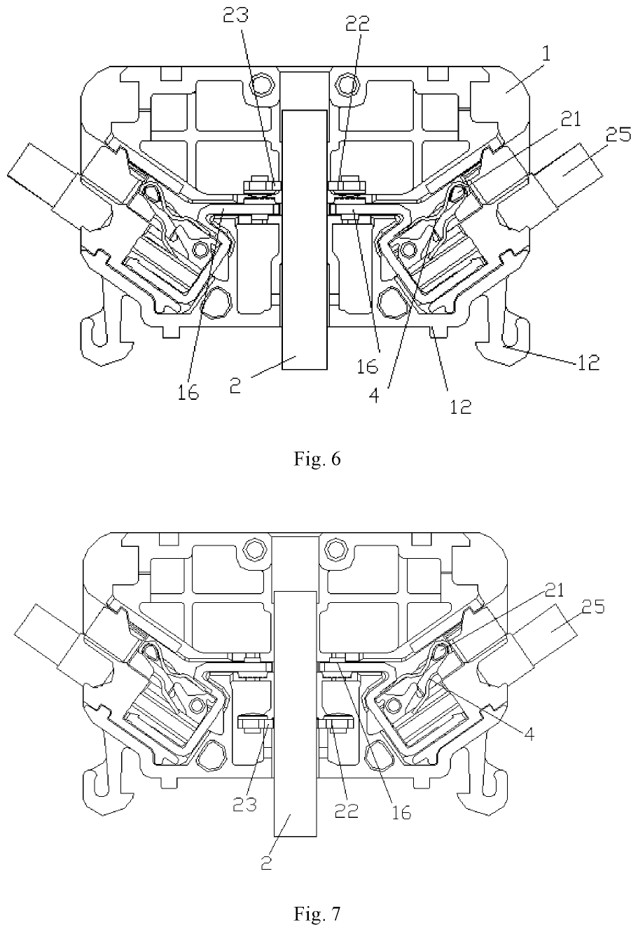

In the implementation process, the contact module has a normally open mode and a normally closed mode, as shown in FIG. 6 and FIG. 7, which are schematic diagrams of the contact modules in two different modes.

The preceding description of the present disclosure is provided to enable any person skilled in the art to practice or exploit the present disclosure. Various modifications to this disclosure will be readily apparent to those skilled in the art, and the generic principles defined herein may be applied to other variations without departing from the spirit or scope of this disclosure. Thus, the present disclosure is not intended to be limited to the examples and designs described in the specification, but is to be accorded the widest scope consistent with the principles and novel features disclosed herein.

It can be seen from the above technical solutions that the wiring unit body includes unit housing 5, spring 4, and contact current bar 6. During the installation process, the spring 4 and the contact current bar 6 are separately fixed by the unit housing 5 made of plastic and then installed in the housing, which makes the assembly more convenient. And the spring 4 is surrounded within the contact current bars 6. Since the hardness of the contact current bar 6 is higher than the hardness of the plastic in the prior art, the deformation of the unit housing 5 made of plastic material is avoided when the use temperature is high. Meanwhile, as the contact current bar 6 is metal, thus it has good electrical conductivity, has a better function of realizing power transmission, and is easy for personnel to operate. It also overcomes the problems caused by the approach in the prior art, including a bare metal end of the conductor wire damaging the housing or causing deflection of the metal elastic piece, scratching the housing, unstable clamping, etc.

Compared with the prior art, situations in the prior art are significantly improved, the situations improved comprising: where the disassembly and assembly of the electrical distribution circuit or the conductor wire 25 through troublesome operation of screw locking and loosening is necessary, the screw may be skewed when the screw is in the loosened state, causing trouble and difficulty for personnel to operate the screw to align with the operation of locking the conductor wire 25 and the electrical connector; or, the application of a-type metal elastic piece, providing matching structure on the insulating housing and the electrical joint for mating with guiding grooves, guiding bars and spring 4, would make the structure more complicated, increase the manufacturing cost and the volume of the casing; or, loosening of the screws and conductor wire rod caused by the vibration of the machine and equipment, etc..

Compared with the prior art where the insertion port for the conductor wire 25 is designed at the lower end of the product, in the present disclosure the extension line of the insertion port 13 for the conductor wire 25 intersects with the extension line of the movement direction of the middle pole, and the side of the housing is provided with a conductor wire insertion port 13 for the conductor wire 25 to be inserted into the electrically conductive part. This wiring method enables multiple contact modules to be superimposed when multiple contact modules need to be connected, which improves the application scenario of the product.

Although the present disclosure has been disclosed above with preferred examples, it is not intended to limit the present disclosure. Those skilled in the art to which the present disclosure pertains can make various changes and modifications without departing from the spirit and scope of the present disclosure. Therefore, the protection scope of the present disclosure should be determined according to the claims.

1. A contact module, comprising a housing, a middle pole, and wiring unit body, wherein:
the middle pole and the wiring unit are disposed in the housing;
the middle pole is configured to move up and down in the housing to realize a connection or disconnection between the middle pole and the wiring unit;
the wiring unit body is disposed inside the housing, and the wiring unit body includes an electrically conductive part to provide the connection between conductor wire and the wiring unit body, and a pressing part to provide the withdrawal of the conductor wire from the electrically conductive part of the wiring unit body, and the conductor wire connected into the electrically conductive part being configured to be pulled out by operating the pressing part; wherein the housing is provided with conductor wire insertion port for the conductor wire to be inserted into the electrically conductive part, wherein the housing is provided with a pressing hole configured to accommodate the pressing part, the pressing part being configured to move up and down along the central axis of the pressing hole.

2. The contact module according to claim 1, wherein an extension line of the insertion port for the conductor wire intersects an extension line of movement direction of the middle pole.

3. The contact module according to claim 1, wherein sides of the housing are provided with conductor wire insertion ports for the conductor wires to be inserted into the electrically conductive parts.

4. The contact module according to claim 2, wherein sides of the housing are provided with conductor wire insertion ports for the conductor wires to be inserted into the electrically conductive parts.

5. The contact module according to claim 1, wherein the wiring unit body comprises a unit housing, a spring, and a contact current bar, wherein:
the contact current bar is disposed in the unit housing, and one end of the contact current bar is arranged to be in contact with or separated from the middle pole, and the other end of the contact current bar is provided with a spring installation cavity, wherein the spring is arranged in the spring installation cavity, and a middle part of the spring is sleeved on a fixing part provided on the unit housing.

6. The contact module according to claim 2, wherein the wiring unit body comprises a unit housing, a spring, and a contact current bar, wherein:
the contact current bar is disposed in the unit housing, and one end of the contact current bar is arranged to be in contact with or separated from the middle pole, and the other end of the contact current bar is provided with a spring installation cavity, wherein the spring is arranged in the spring installation cavity, and a middle part of the spring is sleeved on a fixing part provided on the unit housing.

7. The contact module according to claim 3, wherein the wiring unit body comprises a unit housing, a spring, and a contact current bar, wherein:
the contact current bar is disposed in the unit housing, and one end of the contact current bar is arranged to be in contact with or separated from the middle pole, and the other end of the contact current bar is provided with a spring installation cavity, wherein the spring is arranged in the spring installation cavity, and a middle part of the spring is sleeved on a fixing part provided on the unit housing.

8. The contact module according to claim 4, wherein the wiring unit body comprises a unit housing, a spring, and a contact current bar, wherein:
the contact current bar is disposed in the unit housing, and one end of the contact current bar is arranged to be in contact with or separated from the middle pole, and the other end of the contact current bar is provided with a spring installation cavity, wherein the spring is arranged in the spring installation cavity, and a middle part of the spring is sleeved on a fixing part provided on the unit housing.

9. The contact module according to claim 1, wherein the wiring unit body comprises a unit housing, two springs, and a contact current bar, wherein:
the contact current bar is disposed in the unit housing, the unit housing is provided therein with a middle separation cavity, the two springs are located on both sides of the middle separation cavity respectively, one end of the contact current bar is arranged to be in contact with or separated from the middle pole, and the other end of the contact current bar includes a first pin and a second pin, wherein the first pin, the second pin and the contact current bar form two spring installation cavities, wherein the two springs are respectively arranged in the spring installation cavities, and a middle part of the spring is sleeved on a fixing part provided on the unit housing.

10. The contact module according to claim 2, wherein the wiring unit body comprises a unit housing, two springs, and a contact current bar, wherein:
the contact current bar is disposed in the unit housing, the unit housing is provided therein with a middle separation cavity, the two springs are located on both sides of the middle separation cavity respectively, one end of the contact current bar is arranged to be in contact with or separated from the middle pole, and the other end of the contact current bar is includes a first pin and a second pin, wherein the first pin, the second pin and the contact current bar form two spring installation cavities, wherein the two springs are respectively arranged in the spring installation cavities, and a middle part of the spring is sleeved on a fixing part provided on the unit housing.

11. The contact module according to claim 3, wherein the wiring unit body comprises a unit housing, two springs, and a contact current bar, wherein:
the contact current bar is disposed in the unit housing, the unit housing is provided therein with a middle separation cavity, the two springs are located on both sides of the middle separation cavity respectively, one end of the contact current bar is arranged to be in contact with or separated from the middle pole, and the other end of the contact current bar includes a first pin and a second pin, wherein the first pin, the second pin and the contact current bar form two spring installation cavities, wherein the two springs are respectively arranged in the spring installation cavities, and a middle part of the spring is sleeved on a fixing part provided on the unit housing.

12. The contact module according to claim 4, wherein the wiring unit body comprises a unit housing, two springs, and a contact current bar, wherein:
the contact current bar is disposed in the unit housing, the unit housing is provided therein with a middle separation cavity, the two springs are located on both sides of the middle separation cavity respectively, one end of the contact current bar is arranged to be in contact with or separated from the middle pole, and the other end of the contact current bar includes a first pin and a second pin, wherein the first pin, the second pin and the contact current bar form two spring installation cavities, wherein the two springs are respectively arranged in the spring installation cavities, and a middle part of the spring is sleeved on a fixing part provided on the unit housing.

13. The contact module according to claim 5, wherein the spring installation cavity has a first mounting side, a second mounting side and a connecting side connecting the first mounting side and the second mounting side.

14. The contact module according to claim 13, wherein the spring has a fixing end, a first elastic contact pin, and a second elastic contact pin, wherein:
the first elastic contact pin is in contact with the first mounting side; the second elastic contact pin is in contact with or separated from the second mounting side; when the conductor wire enters the wiring unit, the conductor wire is located between the second elastic contact pin and the second mounting side, and at this moment, the second elastic contact pin is in a separated state from the second mounting side; when the conductor wire exits the wiring unit, the second elastic contact pin is in a contact state with the second mounting side.

15. The contact module according to claim 5, wherein the unit housing and the housing cooperate to form a space configured to accommodate the spring and the contact current bar.

16. The contact module according to claim 1, wherein the pressing part includes a pressing main body, wherein a pressing groove is provided on an upper end surface of the pressing main body, and the pressing groove is configured to receive the pressing part configured to move along the wiring unit body.

17. The contact module according to claim 1, wherein a bottom of the housing includes mounting legs, and an upper part of the housing includes mounting grooves, wherein the mounting legs are configured to be matched with the mounting grooves, and the matching of the mounting legs with the mounting grooves enables superposition of multiple contact modules.

18. The contact module according to claim 1, wherein the middle pole of the housing is arranged in a middle of the housing, and wiring unit bodies are respectively provided on both sides of the middle pole, wherein the middle pole includes a middle pole main body, a contact slider, a first contact spring and a second contact spring, wherein;
an installation cavity is provided in the middle pole main body, a first installation cavity and a second installation cavity are provided in the installation cavity, and the first contact spring and the second contact spring are respectively arranged in the first installation cavity and the second installation cavity; the contact slider is disposed between the first contact spring and the second contact spring; the contact slider includes a first arm and a second arm, and the first arm and the second arm are used to be in contact with or separated from the wiring unit bodies arranged on both sides of the middle pole.

19. The contact module according to claim 5, wherein the spring comprises a V shape with an opening and has a first section, a second section, and a curved section connecting the first and second sections, wherein the first section is in contact with the first mounting side of the spring installation cavity, the second section is a bifurcated structure so as to have a first leg and a second leg, wherein the first leg and the second leg are located on both sides of the middle separation cavity, respectively; the first leg and the second leg are respectively in contact with or separated from the second mounting side; when the conductor wires are inserted into the wiring unit from the two wire insertion ports, the conductor wires are located between the first leg and the second mounting side and between the second leg and the second mounting side, and at this moment, the first leg and the second leg are both in a separated state from the second mounting side; when the conductor wires are extracted from the wiring unit body, the first leg and the second leg are automatically brought into contact with the second mounting side under the force applied by the spring.

20. The contact module according to claim 1, wherein the housing is provided thereon with conductor wire test hole.
